(19) United States
(12) Patent Application Publication
(10) Pub. No.: US 2004/0242841 A1
(43) Pub. Date: Dec. 2, 2004

(54) Methods for extending amorphous photorefractive material lifetimes

(76) Inventors: J. Kevin Cammack, Oceanside, CA (US); Chris Castello, Vista, CA (US); Peng Wang, Oceanside, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/800,934

(22) Filed: Mar. 15, 2004

Related U.S. Application Data
(60) Provisional application No. 60/456,079, filed on Mar. 18, 2003.

(51) Int. Cl. C08F 6/00

(52) U.S. Cl. 528/481; 528/503

(57) ABSTRACT

Methods for significantly improving the working lifetime of photorefractive materials and photorefractive articles involve annealing the photorefractive materials at a temperature higher than the temperature range in which degradation occurs. The methods are particularly applicable to amorphous photorefractive materials and devices in which phase separation results in performance degradation or device failure.

### RELATED APPLICATION INFORMATION

This application claims priority to U.S. Provisional Patent Application No. 60/456,079, filed March 18, 2003, which is hereby incorporated by reference in its entirety.

### BACKGROUND OF THE INVENTION

1. Field of the Invention

This invention relates generally to photorefractive materials. More particularly, this invention relates to methods of heating photorefractive materials to extend their lifetimes.

2. Description of the Related Art

Photorefractive materials are materials that undergo a change in refractive index when illuminated with light. A variety of photorefractive materials are known, including inorganic photorefractive materials such as lithium niobate and amorphous photorefractive materials such as photorefractive polymers. Optical devices incorporating photorefractive materials have been fabricated and many have shown promise for applications such as holographic data storage, optical signal amplification, optical switches, and optical correlators.

The discovery of a photorefractive effect in organic systems and the subsequent design of organic composites with high diffraction efficiencies has greatly increased the potential of photorefractive materials. Amorphous photorefractive materials, especially those containing polymers, have been of particular interest because of their structural flexibility and the general ease with which they can be fabricated into various shapes suitable for incorporation into devices. However, the photorefractive properties of many of the most promising amorphous photorefractive materials have been found to degrade over time, resulting in relatively short useful lifetimes. The degradation mechanism is not completely understood, but is believed to be due at least in part to phase separation of various constituents within the amorphous photorefractive material. For example, the preparation of a promising class of amorphous photorefractive materials involves, inter alia, dissolving a polymer and a chromophore in a solvent to form a solution, then casting a film from the solution by allowing the solvent to evaporate. The resulting photorefractive material comprises a transparent amorphous film which has been found to gradually phase separate over time, leading to degraded photorefractive capability and eventually to rapid, spectacular, and irreversible device failure under conditions of use.

The problem of short photorefractive material lifetimes has been recognized and a variety of approaches for addressing this problem have been reported. See, e.g., E. Hendrickx et al., “Phase stability of guest/host photorefractive polymers studied by light scattering experiments,” Appl. Phys. Lett., Vol. 71(9), pp. 1159-1161 (1997); A. Grunnet-Jepsen et al., “High performance photorefractive polymer with improved stability,” Appl. Phys. Lett., Vol. 70(12), pp. 1515-1517 (1997); A. M. Cox et al., “Crystallization-resistant photorefractive polymer composite with high diffraction efficiency and reproducibility,” Appl. Phys. Lett., Vol. 68(20), pp. 2801-2803 (1996); E. Hendrickx et al., “Synthesis and Characterization of Highly Efficient Photorefractive Polymer Composites with Long Phase Stability,” Macromolecules, Vo. 31, pp. 734-739 (1998); and K. Meerholz et al., “Stability Improvement of High-Performance Photorefractive Polymers Containing Eutectic Mixtures of Electro-optic Chromophores,” Adv. Mater., Vol. 9(13), pp. 1043-1046 (1997). However, these approaches have generally focused on modifying the physical properties of the photorefractive material itself, and have not been widely adopted because the resulting modified materials generally are difficult to prepare and/or have undesirably lower efficiencies or longer response times.

It is known that the lifetimes for amorphous photorefractive materials are generally shorter at higher temperatures. For amorphous photorefractive materials that contain a polymer matrix and a chromophore, this effect has been attributed to the increased rate of phase separation at elevated temperatures. See, e.g., E. Hendrickx et al., “Phase stability of guest/host photorefractive polymers studied by light scattering experiments,” Appl. Phys. Lett., Vol. 71(9), pp. 1159-1161 (1997); and K. Meerholz et al., “Stability Improvement of High-Performance Photorefractive Polymers Containing Eutectic Mixtures of Electro-optic Chromophores,” Adv. Mater., Vol. 9(13), pp. 1043-1046 (1997). Thus, at least in theory, the lifetimes of amorphous-photorefractive materials can be extended by keeping them at relatively low temperatures. However, when applied to a device incorporating a photorefractive article, this method of extending amorphous photorefractive material lifetimes can have a profoundly negative impact on photorefractive properties such as response time and diffraction efficiency. In addition, maintaining a photorefractive article at a low temperature is generally not practical because of the wide temperature variations experienced in manufacturing, shipping, storage and practical use, and the difficulties associated with refrigerating optical devices. Therefore, there remains a long-felt need for methods of extending photorefractive material lifetimes that do not depend on refrigeration of the device or modification of the materials themselves.

### SUMMARY OF THE INVENTION

In preferred embodiments, the present invention provides methods for extending the shelf life and/or the useful lifetime of an amorphous photorefractive material by thermal annealing. The present invention also provides photorefractive articles and devices incorporating heat sources. Thermal annealing of an amorphous photorefractive material and incorporation of a heater directly into a photorefractive article or device provide the capability to utilize amorphous photorefractive materials with relatively short lifetimes but desirable photorefractive properties, particularly in integrated optical systems and devices.

It has been discovered that, surprisingly, heating a degraded amorphous photorefractive material above a certain temperature results in substantial or total regeneration of the photorefractive properties of the sample. In preferred embodiments, repeated degradation-regeneration does not result in any statistically significant change in the photorefractive properties of the amorphous photorefractive material.

Photorefractive articles are also provided that have the capability to utilize the preferred methods described herein. Preferably, these articles comprise a heat source capable of heating the photorefractive material. In a preferred embodiment, heat is provided by one or more heating elements. Preferably, the heating elements are in direct contact with the amorphous photorefractive material, or separated from the amorphous photorefractive material by substrate, sealing material or space.

Heat may also be provided to the photorefractive material by infrared or microwave irradiation. Thus, in preferred embodiments, the photorefractive device comprises a solid state laser or a black body radiator, or are heated by light captured from other portions of the optical system.

Thus, a preferred embodiment provides a method for extending the lifetime of a photorefractive material or removing voids, cracks or other defects in a photorefractive material, comprising:

providing a photorefractive material, wherein the photorefractive material has an optical property that degrades when the photorefractive material is maintained at a temperature in the range of T_{1 to T}₂;

heating the photorefractive material to a temperature T₃ or higher for an annealing time that is effective to maintain or at least partially restore the optical property, wherein T₃ is greater than T₂; and

cooling the photorefractive material to a temperature in the range of T₁ to T₂.

Another preferred embodiment provides a photorefractive article with an extended lifetime, comprising:

a photorefractive material, wherein the photorefractive material has an optical property that degrades when the photorefractive material is maintained at a temperature in the range of T_{1 to T}₂; and wherein the optical properties of the photorefractive material are at least partially restored upon heating the photorefractive material to a temperature T₃ and cooling the photorefractive material to a temperature in the range of T_{1 to T}₂;

a heat source operatively disposed to heat the photorefractive material; and

a substrate in contact with the photorefractive material.

These and other embodiments are described in greater detail below.

### BRIEF DESCRIPTION OF THE DRAWINGS

These and other aspects of the invention will be readily apparent from the following description and from the appended drawings (not to scale), which are meant to illustrate and not to limit the invention, and wherein:

FIG. 1A shows a plot over 12 cycles of degradation-regeneration of the diffraction efficiency of the amorphous photorefractive material used in Examples 1-13 (Run 1) and Examples 14-26 (Run 2).

FIG. 1B shows a plot over 12 cycles of degradation-regeneration of the fast component of the response times of the amorphous photorefractive material used in Examples 1-13 (Run 1) and Examples 14-26 (Run 2).

FIG. 1C shows a plot over 12 cycles of degradation-regeneration of the slow component of the response times of the amorphous photorefractive material used in Examples 1-13 (Run 1) and Examples 14-26 (Run 2).

FIG. 1D shows a plot over 12 cycles of degradation-regeneration of the relative contribution of the fast component of the response time to the overall response time of the amorphous photorefractive material used in Examples 1-13 (Run 1) and Examples 14-26 (Run 2).

FIG. 2 shows a bar graph of the diffraction efficiencies of the amorphous photorefractive material used in Examples 1-13 (Run 1) averaged over 12 degradation-regeneration cycles, as compared to the diffraction efficiency after the amorphous photorefractive material was kept at room temperature for 55 days, and after heating the 55 day old sample to 160° C. for 10 minutes.

FIG. 3A shows a front perspective view schematically illustrating a thermally regenerable photorefractive article according to a preferred embodiment in which a heating element contacts the substrate.

FIG. 3B shows a side view schematically illustrating the thermally regenerable photorefractive article illustrated in FIG. 3A.

FIG. 4A shows a top view schematically illustrating the top edge of a thermally regenerable photorefractive article according to a preferred embodiment in which heating elements are embedded in the amorphous photorefractive material.

FIG. 4B shows a front perspective view schematically illustrating the thermally regenerable photorefractive article illustrated in FIG. 4A.

FIG. 5 shows a side view schematically illustrating a thermally regenerable photorefractive article according to a preferred embodiment in which infrared radiation is used to heat the amorphous photorefractive material.

### DETAILED DESCRIPTION OF THE PREFERRED EMBODIMENTS

Definitions

A “polymer” is a large molecule that contains recurring units formed by polymerizing monomers. A polymer may be a “homopolymer” comprising recurring units formed by, e.g., polymerizing a particular monomer, or it may be a “copolymer” comprising recurring units formed by, e.g., copolymerizing two or more different monomers. A polymer has a weight average molecular weight of about 1,000 or greater.

An “aromatic group” is a cyclic group of carbon atoms that contains 4n+2 π electrons where n is an integer. A “heteroaromatic group” is a cyclic group of atoms, with at least one atom within the ring being an element other than carbon, that contains 4n+2 π electrons where n is an integer. A more extended description of aromaticity and heteroaromaticity can be found in J. March, Advanced Organic Chemistry: Reactions, Mechanisms and Structure, Fourth edition, Wiley-Interscience, New York, 1992, Chapter 2, which is incorporated herein by reference. A “heteroatom” is an atom in group IV, V, VI, or VII in the periodic table other than carbon, such as Nitrogen, Oxygen, Silicon, Phosphorous or Sulfur.

The symbols “‡” and “*” in a chemical structure identify the atom of attachment to a another group and indicates that the structure is missing a hydrogen that would normally be implied by the structure in the absence of the symbol.

An “electron donating group” or “donor” is a chemical group that delocalizes electron density towards the group to which it is attached. An “electron accepting group” (EAG) or “acceptor” is a chemical group that attracts electron density from the group to which it is attached. In this context, a hydrogen substituent is neither electron donating nor electron withdrawing. A more detailed description of these terms is found in J. March, Advanced Organic Chemistry: Reactions, Mechanisms and Structure, Fourth Edition, Wiley-Interscience, New York, 1992, Chapter 9, which is incorporated herein by reference.

A “chromophore” is a molecule or aggregate of molecules that can absorb electromagnetic radiation. An “excited state” is an electronic state of a molecule in which the electrons populate an energy state that is higher than another energy state for the molecule.

An “NLO chromophore” (or non-linear optical chromophore) is a chromophore that exhibits a non-linear optical response to an electric field induced polarization. The induced polarization of the chromophore P is a nonlinear function of the electric field strength E and can be approximated by the Taylor series expansion in equation (1):

P=αE+½!βE²+⅓!γE³+. . .

where E is the electric field strength, α is the linear polarizability, β is the first hyperpolarizability and γ is the second hyperpolarizability. Second order nonlinear optical effects arise from the ½!βE² term of equation 1 and occur only in noncentrosymmetric molecules.

The relative photorefractive response of an NLO chromophore can be determined as described in U.S. Pat. No. 6,090,332 from the photorefractive figure of merit (FOM) of the chromophore as determined by equation 2:

$$FOM = \frac{2}{9 kT} {μ}^{2} Δ α + μ β \qquad ( 2 )$$

where kT is the thermal energy, Δα is polarizability anisotropy of the chromophore (Δα=α_{zz}−Σα_{zz}, where z is the direction of the molecular axis, α_{zz} is the polarizability along the direction of the molecular axis of the molecule and Σαₓₓ is the sum of the polarizability in the plane normal to z), μ is the dipole moment of the NLO chromophore and β is the hyperpolarizability of the chromophore. U.S. Pat. No. 6,090,332 is hereby incorporated by reference in its entirety and particularly for the purpose of describing the relative photorefractive response of an NLO chromophore.

A “photoconductive” material is a material having a degree of electrical conductivity that changes when the material is exposed to electromagnetic radiation. A photorefractive material is a photoconductive material having a refractive index that changes when the material is exposed to electromagnetic radiation.

Methods for Regenerating Photorefractive Materials and Articles

In preferred embodiments, a thermal approach is taken to provide a method for regeneration of an amorphous, glassy state of an amorphous photorefractive material and of photorefractive articles comprising amorphous photorefractive materials. Under preferred conditions of use, the amorphous photorefractive material is maintained in some temperature range, T₁ to T₂. Amorphous photorefractive materials typically contain several components mixed in a metastable, glassy, amorphous state. The metastable amorphous state is known to undergo temperature dependent spontaneous degradation. Generally the degradation occurs more quickly at the higher or T₂ end of the temperature range than at the lower or T₁ end of the range. The photorefractive properties, particularly diffraction efficiency, response time and turn on bias are known to be adversely affected by degradation of the amorphous photorefractive material. Some examples of physical changes which degrade the photorefractive performance include crystallization, separation of individual components into separate, non-crystalline domains, aggregation of one or more components and formation of permanent or quasi-permanent gratings.

Preferably the lower bound, T₁, is in the range of low temperatures that can be reasonably expected to occur in the natural environment. Preferably T₁ is at or below 0° C., more preferably T₁ is at or below about −50° C. Preferably the upper bound, T₂, is at or above about the glass transition temperature (Tg) of the photorefractive material. Preferably the absolute value of T₂ is at or below about 100° C.

Surprisingly, thermal annealing for a sufficient amount of time of a degraded amorphous photorefractive material at a temperature T₃ above T₂ and T₁ of the amorphous photorefractive material allows the active amorphous state of the amorphous photorefractive material to be regenerated. For example, an exemplary photorefractive material, vide infra, was observed to show a linear temperature dependence of the degradation time between T₁=0° C. and T₂=80° C. It was calculated that the amorphous photorefractive material should completely degrade in less than 30 seconds at 150° C. In a procedure that involved heating a film of the amorphous photorefractive material at 150-200° C. for no less than 20 minutes, surprisingly degradation was not observed. Instead, after cooling the film of amorphous photorefractive material to room temperature, it was found that the film was amorphous, clear and exhibited photorefractive behavior.

Surprisingly, it was found that voids and cracks induced by various degradation mechanisms such as crystallization or phase separation could be eliminated by this method. There is normally a volume change associated with crystallization and phase separation. Samples that are allowed to completely crystallize are subject to internal shear stress and have a tendency to delaminate from the electrode and to crack. The cracking and delamination creates voids and grain boundaries in the initial melt. It was discovered that extended thermal treatment led to the healing of these cracks and voids.

Surprisingly, it was found that the useful working lifetime of a photorefractive composite, polymer, plastic, film or device could be extended at least about 16-fold when failure is due to degradation related effects. The shelf life of a photorefractive composite, polymer, plastic, film or device may be extended indefinitely by this method when failure is due to degradation related effects.

A particular amorphous photorefractive material may rapidly degrade, but have useful photorefractive properties. Such a material may, for example, have an extremely fast response. Photorefractive devices may be built from a rapidly degrading material and their photorefractive properties such as response time, two-beam coupling gain and steady state diffraction efficiency quickly measured. The devices may then be subjected to increased temperature (90° C.) to accelerate device failure (degradation). It was found that, when placed under bias without regeneration, degraded test devices failed spectacularly (arcing, sparking and ultimately burning the device). Surprisingly, when other similarly degraded test devices were thermally treated at 160° C. for 10 minutes, the optical properties and response of the device prior to phase separation were substantially regained. Furthermore, surprisingly, this cycle of treatment could be repeated for at least 16 cycles with no statistically significant change in the photorefractive properties of the device.

The annealing time is typically dependent on the nature of the amorphous photorefractive material and ideally specifically identified for a given photorefractive material. Generally, it is preferable that the amorphous photorefractive material be annealed for about 1 minute or longer, more preferably for about 5 minutes or longer.

Preferred annealing temperatures, T₃, are above the Tg of the amorphous photorefractive material. This invention is not bound by theory, but it is believed that in amorphous photorefractive materials there is a phase change somewhere between about 0C.° and about 150C.° above the Tg from a phase segregated cloud region to a eutectic melt. In theory, T₃ should be a higher temperature than that of the phase boundary.

Preferably the amorphous photorefractive material is chosen such that the Tg of the amorphous photorefractive material is in the range of about 0° C. to 150° C., more preferably in the range 0° C. to 100° C., more preferably in the range 15° C. to about 50° C. The annealing temperature, T₃, is preferably more than about 1° C. above the Tg of the amorphous photorefractive material, more preferably more than about 20° C. above the Tg of the amorphous photorefractive material. The absolute value of T₃ is preferably in the range of about 100° C. to about 200° C., more preferably in the range of about 140° C. to about 160° C.

In some embodiments, the cooling rate of the amorphous photorefractive material is also important. This invention is not limited by theory, but it is believed that slow cooling of the photorefractive material increases the amount of time the material is in the temperature range of the cloud phase of the material. It is believed that the longer the material is kept within the cloud phase, the larger the grain size and the more crystalline the photorefractive material becomes. It is theorized that above about a certain critical grain size, the photorefractive material is degraded. Cooling the photorefractive material quickly allows the formation of a glassy state which is at least metastable and which has all of the expected photorefractive properties of the photorefractive material.

Surprisingly, if the heated amorphous photorefractive material is cooled rapidly from T₃ to less than about T₂ after annealing, preferably faster then 5° C. per minute, more preferably faster than about 50° C. per minute, even more preferably faster than about 100° C. per minute, the original photorefractive properties of the amorphous photorefractive material are substantially restored.

Photorefractive Articles

In preferred embodiments, the photorefractive material is a substantially permanent part of a photorefractive article. In the photorefractive article, the photorefractive material is in contact with, preferably affixed to, a substantially transparent substrate that provides mechanical and shape stability. Thus as the temperature is increased, the photorefractive material can soften or undergo a phase change, but deformations or defects that would otherwise be detrimental to the performance of the photorefractive article are not introduced because of mechanical stress. Examples of defects that would be detrimental to the performance of a photorefractive article include the formation of voids, bubbles or cracks, delamination or a change in the thickness or shape of the photorefractive material. Preferred substrates have a shear modulus greater than about 1×10⁷ Pa.

It is preferred that the substrate material is also substantially optically clear, e.g., the optical density is preferably less than about 0.2. More preferably, the optical density of the substrate is less than about 0.05. Preferred substrates include, but are not limited to silica glass, borosilicate glass, gallium nitride, gallium arsenide, sapphire, quartz glass, polyethylene terephthalate (PET), polycarbonate, and other clear materials known to those skilled in the art.

In another preferred embodiment of this invention, a photorefractive article further comprises one or more electrodes, more preferably a pair of electrodes. Preferably the electrodes are substantially in contact with the amorphous photorefractive material and the substrate and comprise a clear, transparent film. A wide variety of suitable thin film electrode materials are known to those skilled in the art, and include conducting metal oxides, conducting polymers, and metals. Preferred electrode materials are chosen from the group consisting of vacuum sputtered conducting metal oxide film, solution coated conducting polymer film, and thermally deposited conducting metal films. Thin film electrodes are typically between about 1 Å and 1000 Å thick. Preferred metal oxide films include, but are not limited to, indium tin oxide (ITO), fluorine doped tin oxide, zinc oxide and cadmium stannate. Preferred conducting polymers include, but are not limited to, polyacetylene, polyaniline and PEDOT/PSS. Preferred conducting metal films include, but are not limited to, gold, silver, copper and aluminum. A more preferred electrode material is a film of ITO which acts as an electrode. The photorefractive material is preferably formed into a clear, amorphous, continuous film typically between 1 and 1000 micrometers thick, generally 100-110 micrometers thick, between two electrodes.

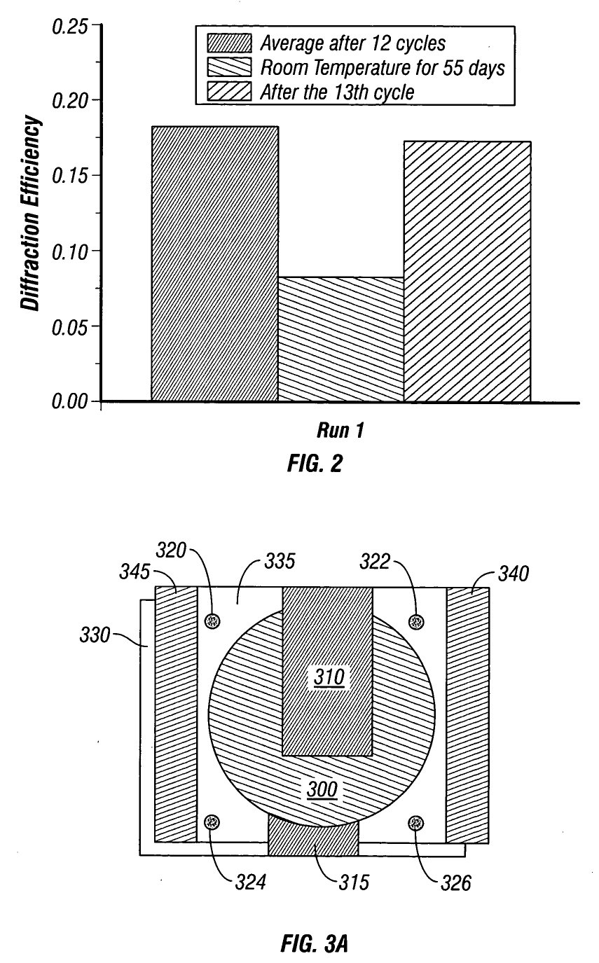

A photorefractive article incorporating a heating element, heating device or infrared irradiation can utilize the thermal method described above to extend its lifetime. FIGS. 3-5 show examples of photorefractive articles that may have their lifetimes extended by the methods described herein.

The materials and photorefractive articles described herein may be fabricated into optical articles for the transmission and control (change phase, intensity, or direction of propagation) of electromagnetic radiation by art-known techniques. A preferred method for the reversal of the optical degradation of photorefractive devices may be applied to amorphous photorefractive materials incorporated into photorefractive articles which may themselves be permanently incorporated into larger devices. Regeneration can be performed after degradation has occurred or can be regularly applied as a preventative measure. A preferred method of regeneration involves heating the amorphous photorefractive material above its Tg, typically to 160° C. for between 1 and 100 minutes. These materials may be formed into thin films by casting or by spin coating. Patterned channel waveguides may be produced with the thin films using standard techniques of lithography or direct laser writing to make waveguide photorefractive devices, such as phase conjugators, mirrors, amplifiers, spatial light modulators, optical processors, or holographic optical storage devices. The methods for making such optical devices are known to those skilled in the art.

Amorphous Photorefractive Materials

The methods described herein are preferably conducted using photorefractive materials, more preferably amorphous photorefractive materials. Amorphous photorefractive materials are known in the art, for example in U.S. Pat. No. 5,064,264, which is hereby incorporated by reference and particularly for the purpose of describing amorphous photorefractive materials.

In a preferred embodiment the amorphous photorefractive material comprises an NLO chromophore. A variety of NLO chromophores known to those skilled in the art may be incorporated into the compositions described herein.

Preferred NLO chromophores have a figure of merit (FOM) as determined by equation (2) of about 10⁻⁴⁹ esu or greater. Example of preferred NLO chromophores include compounds represented by formulae XVI, XVII and XVIII:

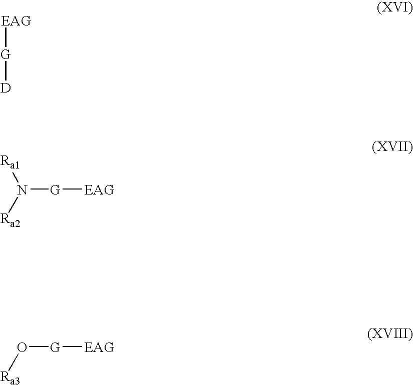

wherein D is an electron donating group, Rₐ₁, Rₐ₂, and Rₐ₃ are selected from the group consisting of a hydrogen atom, a linear alkyl group with up to 10 carbons, a branched alkyl group with up to 10 carbons, an aromatic group with up to 10 carbons and a linking atom; G is either a methyne or a group having a bridge of α-conjugated bonds; and EAG is an electron accepting group. Other suitable NLO chromophores include those disclosed in U.S. Pat. No. 6,0990,332, which is hereby incorporated by reference in its entirety and particularly for the purpose of describing NLO chromophores. Preferred electron donating groups have a relatively low ionization potential and are capable of bonding to a π-conjugated bridge. Exemplary donors, in order of increasing donor strength, include:

I<Br<Cl<F<OC(O)R<SH<OH<SR<OR<NHC(O)R<NH₂<NHR<NR₂<S⁻<O⁻

Additional examples of suitable electron donating groups include those described in U.S. Pat. No. 6,267,913, which is hereby incorporated by reference and particularly for the purpose of describing examples of electron donating groups. Preferred electron donating groups include the following:

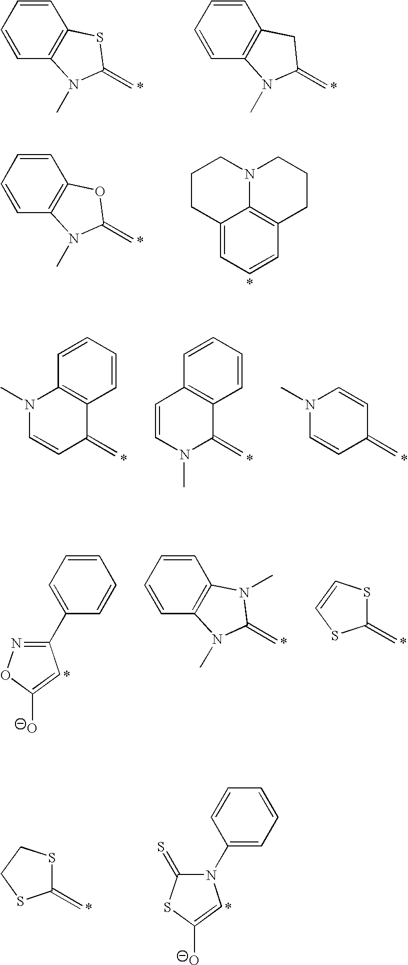

Preferred EAG's have a high electron affinity and are capable of bonding to a π-conjugated bridge. Exemplary acceptors, in order of increasing acceptor strength, include:

C(O)NR²<C(O)NHR<C(O)NH₂<C(O)OR<C(O)OH<C(O)R<C(O)H<CN<S(O)₂R<NO₂

Additional examples of suitable EAG's include those described in U.S. Pat. No. 6,267,913, which is hereby incorporated by reference and particularly for the purpose of describing examples of EAG's. Preferred EAG's include the following:

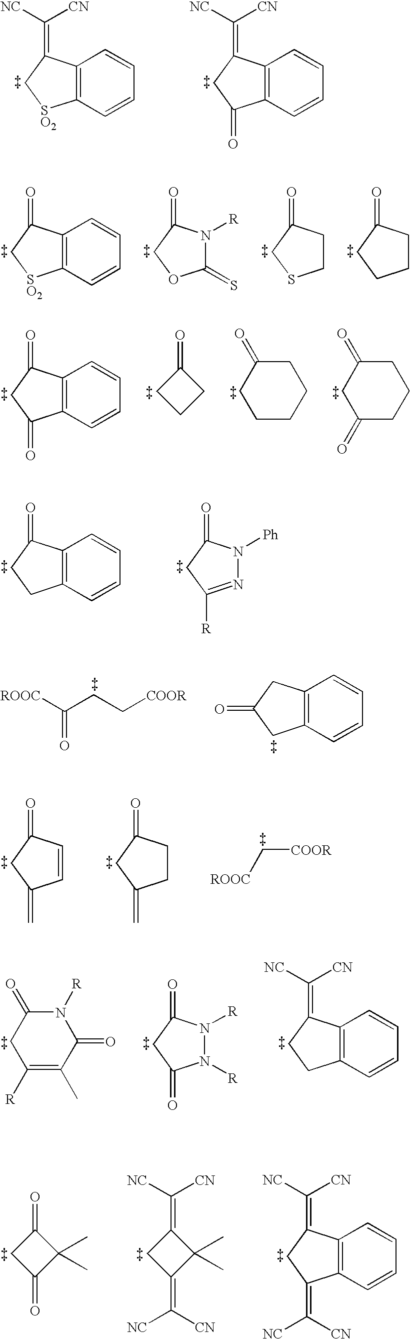

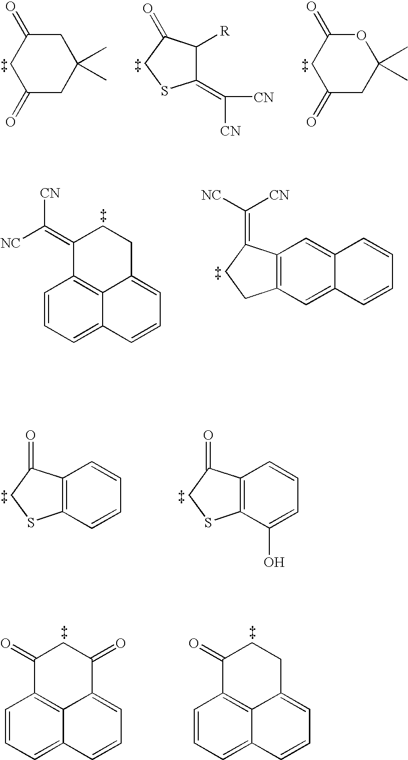

wherein R is selected from the group consisting of a hydrogen atom, a linear alkyl group with up to 10 atoms, a branched alkyl group with up to 10 atoms, and an aromatic group with up to 10 carbons.

In preferred embodiments, G in formulae (XVI), (XVII) and (XVIII) are represented by a structure selected from the group consisting of the structures (XIX), (XX), and (XXI), wherein structures (XIX), (XX), and (XXI) are:

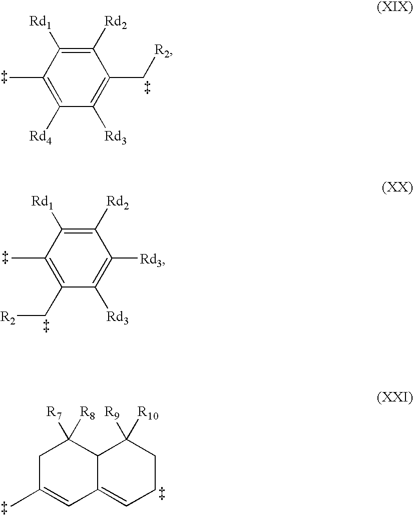

wherein Rd₁-Rd₄ are each independently selected from the group consisting of a hydrogen atom, a linear alkyl group with up to 10 atoms, a branched alkyl group with up to 10 atoms, and an aromatic group with up to 10 carbons; R₂ is selected from the group consisting of a hydrogen atom, a linear alkyl group with up to 10 atoms, a branched alkyl group with up to 10 atoms, and an aromatic group with up to 10 carbons; and R₇₋₁₀ are each independently selected from the group consisting of a hydrogen atom, a linear and branched alkyl group with up to 10 carbons.

In formulae (XVI), (XVII) and (XVIII), EAG is an electron acceptor group, preferably represented by a structure selected from the group consisting of:

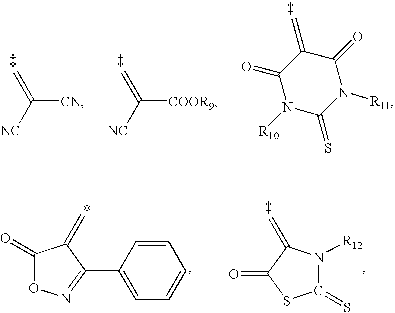

In these structures, R₉, R₁₀, R₁₁, and R₁₂ are each independently selected from the group consisting of a hydrogen atom, a linear alkyl group with up to 10 atoms, a branched alkyl group with up to 10 atoms, and an aromatic group with up to 10 carbons.

In a preferred embodiment, G in formulae (XVII) and (XVIII) is represented by the structure (XXII):

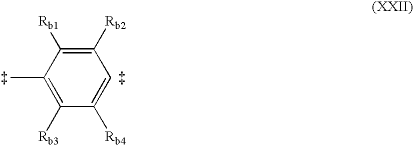

Preferably, EAG in formulae (XVII) and (XVIII) is represented by a moiety selected from the group consisting of:

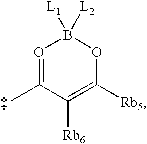

S(O)₂OR₁₃, NO₂, C(O)OR₁₃, S(O)₂R₁₃, S(O)R₁₃, C(O)R₁₃, CN, and C(O)NR₁₄R₁₅,

wherein C(O) represents an oxygen atom attached to C by a double bond, S(O)ₙ represents n oxygen atoms connected to S by a double bond, n is an integer in the range of 1 to 4, R_{b1}, R_{b2}, R_{b3}, R_{b4}, R_{b5}, R₁₃, R₁₄ and R₁₅ are each independently selected from the group consisting of a hydrogen atom, a linear alkyl group with up to 10 atoms, a branched alkyl group with up to 10 atoms, and an aromatic group with up to 10 carbons.

In a most preferred embodiment, the NLO chromophore is (4-(homopiperidinyl)benzylidene)malonitrile (7-DCST):

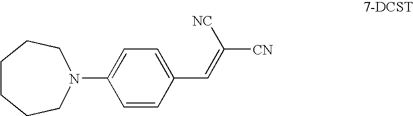

In a preferred embodiment, the photorefractive material further comprises a photo charge-generating agent. A photo charge-generating agent is a material that absorbs light with the result that a separated electron-hole pair is created. The photo charge-generating agent may be the NLO chromophore or a separate moiety added to the photorefractive material for the specific purpose of increasing the number of photoinduced mobile charges. A photo charge-generating agent may also be added to enhance the response at a desired wavelength. Photo charge-generating agents are known to those skilled in the art.

Preferred photo charge-generating agents are selected from the group consisting of fullerene, trinitrofluorenone, (2,4,7-trinitro-9-fluorenylidene)-malonitrile, C₆₀, phthalocyanine, porphyrin, transition metal phthalocyanine and transition metal porphyrin.

The amorphous photorefractive material preferably further comprises a charge transport moiety. The NLO chromophore may act as a charge transport moiety or be a separate component of the amorphous photorefractive material. Charge transport may be one of two general types: electron-transporting or hole transporting and are known to those skilled in the art. In a preferred embodiment, the charge-transporting agent in combination with the photo charge-generating agent provides the photorefractive material with a photoconductivity greater than about 10⁻¹² inverse-ohm centimeter per watt per square centimeter.

Preferred charge transport agents are selected from the group consisting of carbazole, N,N,N′,N′-tetraaryl-4,4′-benzidine (TPD), N,N′-dialkyl-N,N′-diaryl-4,4′-benzidine, N,N,N′,N′-tetraalkyl-4,4′-benzidine, triarylamine, N-alkyl-N-arylaniline, N-dialkylaniline, N,N,N′,N′-tetraaryl-1,4-phenylenediamine, N,N′-dialkyl-N,N′-diaryl-1,4 -phenylenediamine, N,N,N′,N′-tetraalkyl-1,4-phenylenediamine, paraphenylenevinylene (PPV), hydrazone, borondiketonate, oxo-thioxanthene-dioxide and thioxanthene-dioxide.

In a most preferred embodiment, the charge transporting agent is N,N,N′,N′-tetraaryl-4,4′-benzidine.

In a preferred embodiment, the amorphous photorefractive material further comprises a polymer binder. The NLO chromophore, charge-transport agent and photo charge-generating agent may be dispersed in the polymer binder or covalently attached to the polymer binder.

In a preferred embodiment, the polymer binder is chosen from the group consisting of, for example, a polyacrylate, polytrifluorvinylether, poly(arylvinylene), polystyrene, polymethacrylate, polysiloxane, polyether, polyester, polyamide, polyimide, polyurethane, polyphenylenevinylene, polyepoxide, polyfluorocyclobutane, polymaleimide and polycyanate.

In a preferred embodiment, the charge-transport agent is covalently attached to the polymer binder. The charge-transporting agent may be covalently attached as a side chain or as part of the polymer main chain. A more complete description of main chain and side chain polymers is provided in G. Odian, Principles of Polymerization 3^{rd} Ed., John Wiley & Sons, New York, (1991), which is hereby incorporated by reference. Specific examples of amorphous photorefractive materials comprising charge-transporting agents covalently attached to the polymer binder are disclosed in U.S. Pat. Nos. 6,610,809 and 6,653,421, both of which are hereby incorporated by reference and specifically for the purpose of describing amorphous photorefractive materials comprising charge-transporting agents covalently attached to the polymer binder.

In a preferred embodiment of this method, the Tg of the amorphous photorefractive material is below about 200° C., more preferably below about 100° C., more preferably below about 70° C. The Tg of an amorphous photorefractive material comprising a polymer can be controlled by methods known to those skilled in the art, such as, e.g. the addition of a plasticizing agent, control of the molecular weight of the polymer, addition of branched polymers, etc.

Preferably, the amorphous photorefractive material has a Tg below about 100° C., preferably below about 50° C., most preferably within about 5° C. of the temperature of use.

FIGS. 3-5 show examples of photorefractive articles that may have their lifetimes extended by the methods described herein.

It is surprising that the methods described herein may be used to prepare an amorphous, photorefractive composite. For example, in a preparation procedure that involved heating a composite at 150-200° C. for no less than 20 minutes, it was calculated that the devices should completely crystallize in less than 4 minutes at 150° C., and crystallize sufficiently to cause device failure when placed under bias in less than 30 seconds. Surprisingly, this was not observed. Instead, it was found that amorphous films exhibiting photorefractive behavior could be formed. This invention is not bound by theory, but it is believed that there is a phase change from a phase segregated cloud region to a eutectic melt somewhere between 100 and 150° C., and that the initialization of the crystallization process is reasonably slow, because as the device is cooled and the internal temperature passes through the temperature range where the cloud phase exists, no phase separation occurs.

A composite material may rapidly phase separate, but have useful photorefractive properties. Such a material may, for example, have an extremely fast response. Photorefractive devices may be built from a rapidly phase separating material and their photorefractive properties such as response time, two-beam coupling gain and steady state diffraction efficiency quickly measured. The devices may then be subjected to increased temperature (90° C.) to accelerate device failure (phase separation). It was found that, when placed under bias without regeneration, phase separated test devices failed spectacularly (arcing, sparking and ultimately burning the device). Surprisingly, when other phase-separated test devices were thermally treated at 160° C. for 10 minutes, the optical properties and response of the device prior to phase separation were substantially regained. Furthermore, surprisingly, this cycle of treatment could be repeated for at least 16 cycles with no statistically significant change in the photorefractive properties of the device.

Surprisingly, it was found that phase-separation induced voids and cracks could be eliminated by this method. Crystallization of one or more of the small molecule components sometimes accompanies phase separation. Because there is normally a volume change associated with crystallization, samples that are allowed to completely crystallize are subject to internal shear stress and have a tendency to delaminate from the electrode and to crack. The cracking and delamination creates voids and grain boundaries in the initial melt. It was discovered that extended thermal treatment led to the healing of these crystallization induced cracks and voids.

Surprisingly, it was found that the useful working lifetime of a photorefractive composite, polymer, plastic, film or device could be extended at least about 16-fold when failure is due to phase-separation related effects. The shelf life of a photorefractive composite, polymer, plastic, film or device may be extended indefinitely when failure is due to phase-separation related effects.

To distinguish the materials of the preferred embodiments as being photorefractive rather than photochromic, photorefractivity may be determined by any one of three tests depending upon the relative importance of carrier diffusion and external-field-induced drift in the charge transport process. A positive result on any one of these three tests shows that the material exhibits a photorefractive effect. In such cases the diffraction is anisotropic consistent with the symmetry of the electro-optic coefficients for various polarizations. The three tests are:

(1) Reversible anisotropic holographic grating formation with the phase shift between the light intensity pattern and the index of refraction pattern not equal to zero degrees indicates a photorefractive effect in which diffusion dominates over drift in the charge transport process. For example, two coherent beams are overlapped in the material to form a grating. One beam is then attenuated, and the optical phase shift between the transmitted weak beam and the diffracted beam from the remaining strong beam is measured by standard interferometric techniques.

(2) The presence of anisotropic asymmetric two-beam coupling indicates a photorefractive effect in which diffusion dominates over drift. Asymmetric two-beam coupling can be observed when two coherent beams are overlapped in the material and the optical power of the two transmitted beams is measured by art known techniques. Asymmetric two-beam coupling occurs if the optical power of one of the two beams decreases while the optical power in the other beam increases during grating formation.

(3) If drift dominates over diffusion in the charge transport process, then the presence of a photorefractive effect can be determined by the formation of an erasable holographic anisotropic diffraction grating when an external DC electric field is applied to the material during grating formation.

Once the photorefractivity of a material has been established by one of the above methods, the photorefractive properties of the material may then be derived from 4-wave mixing measurements as described below.

The materials described herein may be fabricated into optical devices for the transmission and control (change phase, intensity, or direction of propagation) of electromagnetic radiation by art-known techniques. These materials may be formed into thin films by casting or by spin coating. Patterned channel waveguides may be produced with the thin films using standard techniques of lithography or direct laser writing to make waveguide photorefractive devices, such as phase conjugators, mirrors, amplifiers, spatial light modulators, optical processors, or holographic optical storage devices. The methods for making such optical devices are known to those skilled in the art.

FIGS. 3A and 3B show different views (front and side, respectively) schematically illustrating the structure of a thermally regenerable photorefractive article according to a preferred embodiment in which heating elements 340 and 345 contact a substrate 335. The heating elements 340 and 345 are offset such that there is no overlap between the heating elements and the electrodes 310 and 315. In the illustrated embodiment, the amorphous photorefractive material 300 is substantially in contact with the electrodes 310 and 315. The amorphous photorefractive material 300 is a film having a thickness of about 105 micrometers. The thickness is controlled by spacers 320, 322, 324 and 326, each having a thickness of about 105 micrometers. The spacers, electrodes and amorphous photorefractive material are all substantially in contact with the substrates 330 and 335. However, those skilled in the art and having the benefit of this disclosure will recognize that the amorphous photorefractive material can be thicker or thinner than 105 micrometers and that it is not necessary for the amorphous photorefractive material to be in contact with either of the electrodes 310 and 315 and that it may also be in contact with only one of the substrates 330 and 335.

In the illustrated embodiment, substrates 330 and 335 are prepared with a patterned heating element on one side and a patterned transparent ITO electrode on the other side. The patterned ITO electrode is created by patterning a commercially available ITO on glass substrate using photolithographic methods known to those skilled in the art. Those skilled in the art and having the benefit of this disclosure will recognize that the choice of electrode material is not limited to ITO but can be any conducting film, such as a metal oxide, metal or organic film with an optical density less than 0.2. The film of amorphous photorefractive material is prepared by pressing a melt of amorphous photorefractive material between heated substrates 330 and 335. Those skilled in the art will recognize that there are other methods of preparing films of the amorphous photorefractive material such as spin coating, drop casting and roll-to-roll processing.

FIG. 3B shows a side view schematically illustrating the structure of the thermally regenerable photorefractive article illustrated in FIG. 3A in which heating element 345 is substantially in contact with substrate 335. In this illustration the device has a sandwich structure with the amorphous photorefractive material 300 between and substantially in contact with the electrodes 310 and 315, which are in turn in substantial contact with the substrates 335 and 330, respectively.

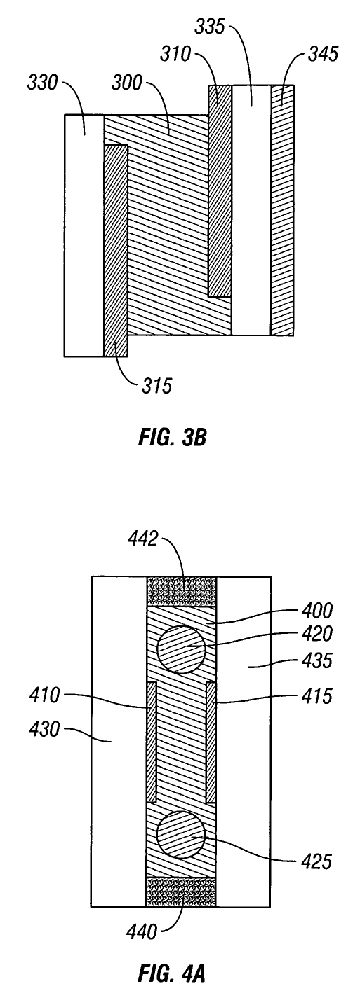

FIGS. 4A and 4B show different views (front and side, respectively) schematically illustrating the structure of a thermally regenerable photorefractive article according to a preferred embodiment in which heating elements are embedded in the amorphous photorefractive material. FIG. 4A shows a view of the top edge of the regenerable photorefractive article and FIG. 4B shows a front perspective view of the regenerable photorefractive article. Two heating elements 420 and 425 contact and are embedded in the amorphous photorefractive material 400. Those skilled in the art will recognize that two heating elements is a representative number and that the actual number of heating elements can vary from one to more than about 100 depending on system and device requirements. Preferably, the heat source is at least partially embedded in the photorefractive material.

In the illustrated embodiment, the amorphous photorefractive material 400 is substantially in contact with the electrodes 410 and 415. The heating elements 420 and 425 are substantially offset from the center of the regenerable photorefractive article, are not in contact with both electrodes 410 and 415 and are not in the active area of the regenerable photorefractive article. The amorphous photorefractive material 400 in this illustration is a film having a thickness of about 105 micrometers. The thickness is controlled by the spacers 440, 442, 444 and 446 (each having a thickness of about 105 micrometers) shown in FIG. 4B. The spacers, electrodes and amorphous photorefractive material are all substantially in contact with the substrates 430 and 435. However, those skilled in the art and having the benefit of this disclosure will recognize that the amorphous photorefractive material can be thicker or thinner than 105 micrometers and that it is not necessary for the amorphous photorefractive material to be in contact with either of the electrodes 410 and 415 and that it may also be in contact with only one of the substrates 430 and 435.

In the illustrated embodiment the heating elements 410 and 415 traverse the regenerable photorefractive article from top to bottom in a substantially straight line. This geometry is intended to illustrate and is not intended to limit the shape, size or orientation of the heating elements. For example, in some cases a U-shaped heating element or circular heating element may be used.

In the illustrated embodiment, the substrates 430 and 435 are prepared with a patterned transparent ITO electrode on one side. The patterned ITO electrode is created by patterning a commercially available ITO on glass substrate using photolithographic methods known to those skilled in the art. Those skilled in the art and having the benefit of this disclosure will recognize that the choice of electrode material is not limited to ITO but can be any conducting film, such as a metal oxide, metal or organic film with an optical density less than 0.2. The film of amorphous photorefractive material is prepared by pressing a melt of amorphous photorefractive material between heated substrates 430 and 435. Those skilled in the art will recognize that there are other methods of preparing films of the amorphous photorefractive material such as spin coating, drop casting and roll-to-roll processing.

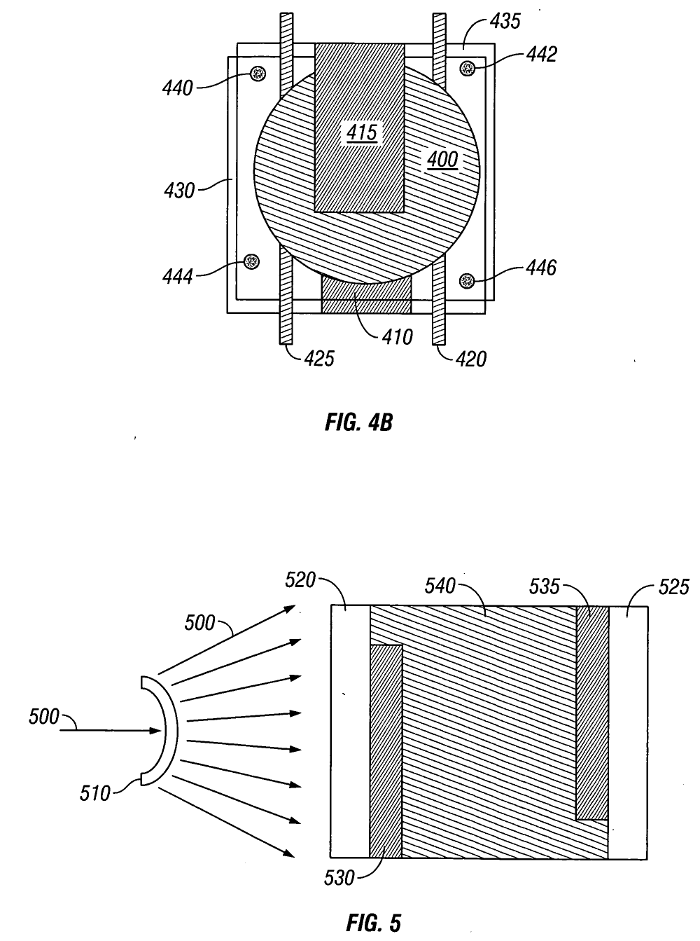

FIG. 5 schematically illustrates a side view of a thermally regenerable photorefractive article according to a preferred embodiment in which infrared or microwave irradiation is used to heat an amorphous photorefractive material 540. In this embodiment, the photorefractive article is prepared as described above for the embodiment illustrated in FIG. 3, except that there are no heating elements in substantial contact with the substrate. The photorefractive article is heated using infrared (IR) radiation 500 from an internal light source (not shown) such as an infrared diode laser. The infrared radiation 500 is focused on the regenerable photorefractive article using a lens 510. However, those skilled in the art will recognize that the infrared radiation source does not need to be a diode laser but can, for example, be from a CO₂ laser, black body radiator or bar heater. In the case where an isotropic infrared emitter such as a bar heater is used, the lens may be unnecessary and the emitter may be used to heat the photorefractive article directly. In the case of a collimated source such as a laser, the infrared source may also be placed such that the lens is between the source and the photorefractive article. In the illustrated embodiment the substrates 520 and 525 and the electrodes 530 and 535 are substantially transparent to the infrared radiation, allowing the amorphous photorefractive material 540 to be exposed to the infrared radiation 500.

The following examples are detailed descriptions of methods of treatment and preparation of preferred materials of the present invention. The detailed preparations fall within the scope of, and serve to exemplify, the more generally described methods of preparation set forth above. The examples are presented for illustrative purposes only, and are not intended as a restriction on the scope of the invention. All temperatures are in degrees Celsius.

### EXAMPLES

Experimental setup for degenerate four-wave mixing (DFWM) measurements: FIG. 9 is a diagram illustrating a typical geometry for the DFWM measurements described below. Two coherent s-polarized 632.8 nm laser beams separated from a cw single model (TE M₀₀) He—Ne laser were incident upon the sample film. The beam waist of each of the writing beams was 0.65 mm on the surface of the sample and their powers were reduced to about 1 mW. During the measurement, an external dc electric field was applied perpendicularly to the sample surface. The tilt angle was φ_{ex t}=60° and the angle between two incident beams was 2θₑₓₜ=20° in air. A much weaker beam with p-polarization (beam 3) counter-propagates in the direction of one of the write beams as the probe beam. The diffracted portion of beam 3 can be then detected as beam 4. The diffraction efficiency is defined as η=I_{diffraction}/I_{probe}. The four-wave mixing efficiency data obtained by varying the applied electric field was fitted according to a simple form of the Kogelnik equation:

η=Asin²[B·E_{applied}^{P}]

in which A, B and P are fit parameters, and E_{applied} is the applied electric field.

The transient DFWM response of the photorefractive (PR) samples was obtained by setting the bias to a fixed value (typically 6 KV) with one of the writing beams blocked, and acquiring data as the writing beam was unblocked. The PR grating built-up property were then fitted to a biexponential function as:

$$η = A {sin}^{2} ⌊ B \cdot ( 1 - m {ⅇ}^{- t / t1} - ( 1 - m ) {ⅇ}^{- t / t2} ) ⌋$$

where A, B and m are fitting parameters, and τ1 and τ2 are the fast and slow response time, respectively.

Experimental setup for two-beam coupling (TBC) measurements: The TBC measurements were performed using the same optical configuration as the DFWM experiments, except that two p-polarized writing beams are used. The two-beam coupling coefficient Γ can be calculated from:

$$Γ = \frac{cos φ}{d} ln ( \frac{b γ}{b + 1 - γ} )$$

where d is the thickness of the sample. b=I₂/I₁, γ=I₁₂/I₁, and I₁ and I₁₂ are the transmitted intensity of beam 1 before and after coupling, respectively. Generally, after the photorefractive grating is built, one of the writing beams will gain energy while the other one lose energy at the same time. The direction of the energy exchange can be reversed if the direction of the applied field is reversed. This so-called asymmetric energy transfer demonstrates the existence of the photorefractive grating.

All hotplates were calibrated using a flat thermometer and surface temperature measurements were made prior to the preparation of each device. For precision heating, a Yamamoto digital surface feedback hotplate (precise to 1° C.) was used. The standard composition used for benchmarking optical measurements is a filled polymer composite consisting of 49.5% by weight of PVK, 35% by weight of 7-DCST, 15% by weight of ethylcarbazole (ECZ), and 0.5% by weight of C₆₀. Polyvinylcarbazole (PVK) (Mw=1,100,000, Tg=200° C.) was obtained from Aldrich Chemical Co.

Rinsed, etched electrodes were wrapped in foil and stored in a closed container or stored standing on end in a drawer. Prior to use, the electrodes were washed 3 times with HPLC (98.5%) grade (or better) acetone. The acetone was applied to a clean, dry, folded Kim-wipe or piece of lens paper, and the surface was wiped several times in the same direction. Following the acetone wash the surface was dried by repeating the wash procedure using electronic grade ethanol or methanol. The slides were then blown clean of dust with a stream of Argon or canned air and used immediately.

Composite materials were prepared as follows: Two flasks were meticulously cleaned by rinsing with reagent grade toluene or CH₂Cl₂ three times. The flasks were then blown clean and dry using a stream of filtered argon or canned air. The components of the composite, e.g., polymer matrix, semiconducting material, electrooptic dye, plasticizer and photosensitizer, were dissolved a solvent in which all components are mutually soluble, typically toluene or chlorobenzene. The components were mixed as solids or solutions in the appropriate weight ratios, and the resulting mixture was stirred in an appropriate volume of solvent until all components were fully dissolved, typically from about 1 to about 24 hours. When the mixture was completely dissolved, the solution was filtered through a 0.2 μm PTFE syringe filter into the second cleaned flask to remove insoluble impurities such as dust. The solvent from the solution was rapidly stripped from the mixture on a rotary evaporator, and the sample was covered with a porous membrane to prevent dust contamination and further dried at 65° C. in a vacuum oven (2 torr) overnight. The resulting powder was an amorphous photorefractive material. A composite sample was then prepared from the amorphous photorefractive material by pressing a portion of the amorphous photorefractive material into a film between two hot, etched glass supported indiumtinoxide electrodes. The resulting electrode-amorphous photorefractive material-electrode sandwich in the composite sample is an active area. Glass beads or PTFE spacers are commercially available in a variety of thicknesses from 1 micrometer to several millimeters and can be used to maintain the film of the amorphous photorefractive material at the desired thickness. Typically the spacers are placed outside of the active area of the composite sample.

### Example 1

A composite sample was prepared from a polymer having N,N,N′,N′-tetraaryl-4,4′-benzidine groups (poly-TPD) (130 mg), 7-DCST (70 mg) and an aliquot of a stock solution of C₆₀ (1.0 mL, 1 mg/mL) by the method described above. The results of four wave mixing and two beam coupling measurements made on this composite sample are shown in Table 1.

### Example 2

The composite sample of Example 1 was phase-separated by heating it to about 90° C. for about 10 minutes, then allowing it to cool to room temperature. The degree of phase separation was about 10% of the area of the sample. This phase separated sample was then regenerated by heating it to 160° C. for about 20 minutes, then allowing it to cool. The results of four wave mixing and two beam coupling measurements made on this regenerated composite sample are shown in Table 1.

### Examples 3-13

The regenerated composite sample of Example 2 was subjected to a series of phase separation/regeneration cycles as described in Example 2 (Run 1). The results of four wave mixing and two beam coupling measurements made on the regenerated composite samples produced at the end of each cycle are shown in Table 1.

TABLE 1

| | | Diffraction | | | |
|---|---|---|---|---|---|
| Ex- | Number | efficiency | Fast response | Slow Response | |
| am- | of | (%) | time (t₁, msec) | time (t₂, msec) | |
| ple | cycles | (at 6 kV) | (at 6 kV) | (at 6 kV) | m |
| 1 | 0 | 19.8 | 12.6 | 477.8 | 72.2% |
| 2 | 1 | 19.6 | 13.0 | 575.5 | 69.8% |
| 3 | 2 | 13.3 | 15.4 | 585.3 | 71.4% |
| 4 | 3 | 19.3 | 12.7 | 502.7 | 68.9% |
| 5 | 4 | 18.3 | 15.5 | 461.6 | 68.8% |
| 6 | 5 | 14.7 | 13.4 | 487.8 | 68.4% |
| 7 | 6 | 17.0 | 13.3 | 513.1 | 71.7% |
| 8 | 7 | 17.5 | 12.9 | 657.6 | 70.8% |
| 9 | 8 | 17.3 | 13.2 | 533.5 | 69.8% |
| 10 | 9 | 19.7 | 13.5 | 449.5 | 71.1% |
| 11 | 10 | 18.1 | 13.3 | 460.5 | 72.6% |
| 12 | 11 | 17.0 | 12.9 | 563.1 | 73.2% |
| 13 | 12 | 22.5 | 13.0 | 516.9 | 73.8% |
| 14 | 0 | 20.9 | 13.2 | 482.9 | 71.9% |
| 15 | 1 | 20.6 | 13.1 | 520.7 | 71.3% |
| 16 | 2 | 19.7 | 13.9 | 617 | 68.6% |
| 17 | 3 | 17.4 | 14.1 | 503.6 | 71.4% |
| 18 | 4 | 18.1 | 12.1 | 438.2 | 70.3% |
| 19 | 5 | 18.3 | 12.5 | 514.3 | 71.4% |
| 20 | 6 | 16.1 | 12.8 | 516.5 | 72.2% |
| 21 | 7 | 17.4 | 13.3 | 532.3 | 71.7% |
| 22 | 8 | 19.7 | 13.3 | 423.8 | 72.4% |
| 23 | 9 | 19.2 | 13.5 | 474.4 | 72.6% |
| 24 | 10 | 20.6 | 14.0 | 471.8 | 72.1% |
| 25 | 11 | 18.1 | 12.5 | 483.8 | 71.4% |
| 26 | 12 | 21.0 | 12.6 | 494.1 | 70.5% |

### Example 14

A composite sample was prepared as described in Example 1. The results of four wave mixing and two beam coupling measurements made on this composite sample are shown in Table 1.

### Example 15

The composite sample of Example 14 was phase-separated by heating it to about 90° C. for about 10 minutes, then allowing it to cool to room temperature. The degree of phase separation was about 10% of the area of the sample. This phase separated sample was then regenerated by heating it to 160° C. for about 10 minutes, then allowing it to cool. The results of four wave mixing and two beam coupling measurements made on this regenerated composite sample are shown in Table 1.

### Examples 16-26

The regenerated composite sample of Example 15 was subjected to a series of phase separation/regeneration cycles as described in Example 15 (Run 2). The results of four wave mixing and two beam coupling measurements made on the regenerated composite samples produced at the end of each cycle are shown in Table 1.

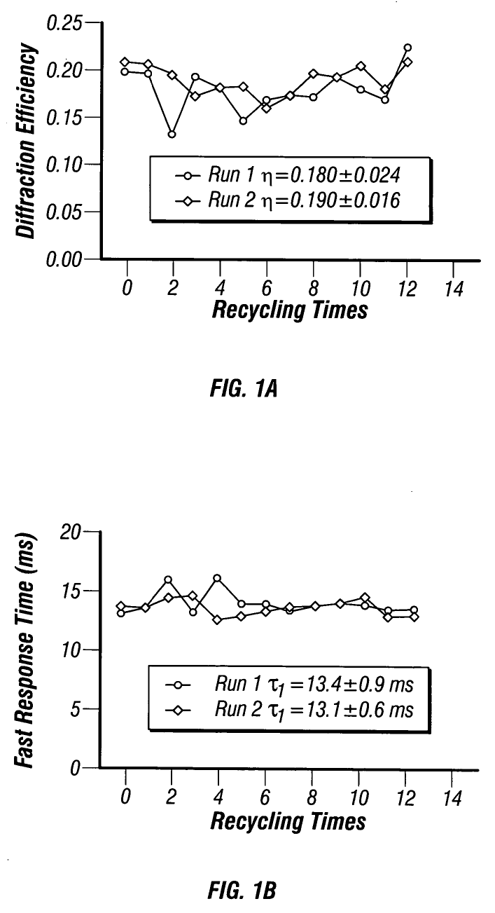

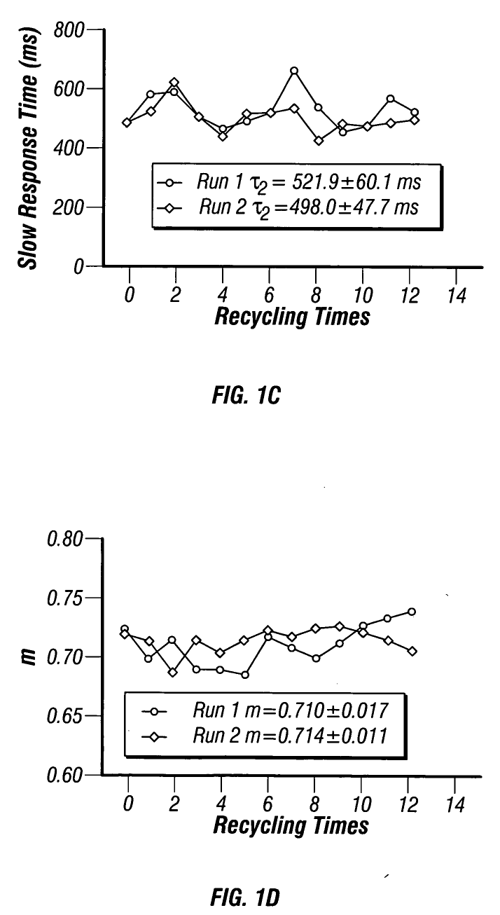

The results obtained in Examples 1-13 (Run 1) and 14-26 (Run 2) are plotted in FIGS. 1A-1D and show that there is no statistically significant change in any of the measured parameters over 12 phase separation/regeneration cycles. FIG. 1A is a plot of the steady state diffraction efficiency η as a function of the number of cycles; FIG. 1B is a plot of the fast component of the response time τ₁ as a function of the number of cycles; FIG. 1C is a plot of the slow component of the response time τ₂ as a function of the number of cycles; and FIG. 1D is a plot of the relative contribution of the fast component of the response time to the overall response time (denoted m) as a function of the number of cycles.

### Examples 27-32

Amorphous photorefractive materials and composite materials were prepared from the compounds listed in Table 2 by the general methods method described above.

### Examples 33-44

The composite samples of Examples 27-32 were phase-separated by heating to about 90° C. for about 10 minutes, then cooling to room temperature. The degree of phase separation was about 10% of the area of the sample. The phase separated samples were then regenerated by heating to 160° C. for about 10 minutes, then cooling. This phase seperation/regeneration process was repeated 5 times for each composite sample. The results of four wave mixing and two beam coupling measurements made on the starting composite samples prepared in Examples 27-32 and on these regenerated composite samples are shown in Table 3. These results show that the thermal annealing method of this invention provides regeneration of the photorefractive properties of degraded amorphous photorefractive materials and photorefractive articles prepared from amorphous photorefractive materials. Further, these results show that the method of this invention is widely applicable to many different photorefractive materials and is not limited by the choice of polymer, organic semiconducting moiety, electrooptic dye, plasticizer or photosensitizer.

TABLE 2

| Ex- | |
|---|---|
| am- | |
| ple | Composition (wt. %) |
| 27 | Poly-TPD (79.5%); AZO (20%); C60 (0.5%) |
| 28 | PVK (64.5%); HR254 (35%); C60 (0.5%) |
| 29 | PVK (49.5%); ECZ (15%); HR254 (35%); C60 (0.5%) |
| 30 | Poly(Carbazolesiloxane) (69.5%); AZO (30%); TNFDM (0.5%) |
| 31 | Poly(Carbazolesiloxane) (64.5%); 7-DCST (35%); TNFDM (0.5%) |
| 32 | Polydioxaborine (64.5%); 7-DCST (35%); C60 (0.5%) |

| | |
|---|---|
| 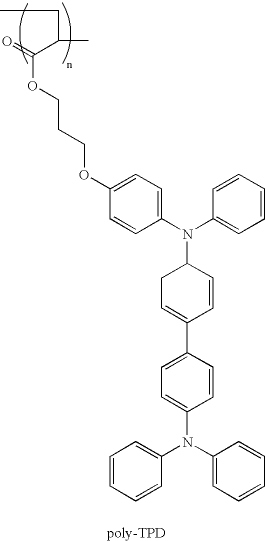 | 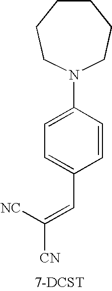 |

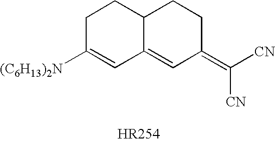

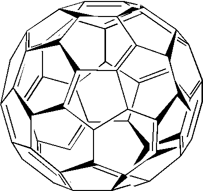

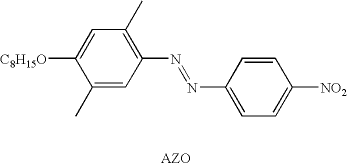

| | |
|---|---|
| 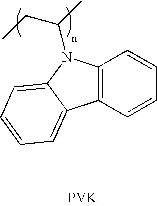 | 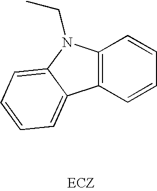 |

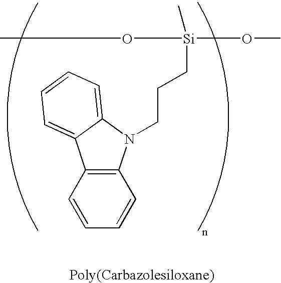

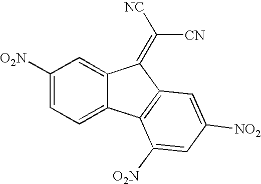

TABLE 3

| | | | Diffraction | Fast response | Slow response | |
|---|---|---|---|---|---|---|
| | Composite | Number of | efficiency (%) | time (t1, msec) | time (t2, msec) | |
| Example | Ex. No. | cycles | (at 6 kV) | (at 6 kV) | (at 6 kV) | m % |
| 33 | 27 | 0 | 4.3 | 17.2 | 483.7 | 81.2 |
| 34 | 27 | 5 | 2.7 | 16.5 | 458.4 | 82.6 |
| 35 | 28 | 0 | 28.7 | 1130 | 8700 | 52.1 |
| 36 | 28 | 5 | 29.3 | 1100 | 10300 | 53.5 |
| 37 | 29 | 0 | 57.5 | 1470 | 7300 | 33.4 |
| 38 | 29 | 5 | 58.8 | 1500 | 6800 | 31.5 |
| 39 | 30 | 0 | 10 | 2400 | 17500 | 72.2 |
| 40 | 30 | 5 | 10 | 2330 | 16700 | 69.1 |
| 41 | 31 | 0 | 56.1 | 1200 | 11500 | 51.6 |
| 42 | 31 | 5 | 52.8 | 1290 | 11200 | 52.1 |
| 43 | 32 | 0 | 16.0 | 1030 | 23400 | 70.3 |
| 44 | 32 | 5 | 16.4 | 1060 | 9800 | 64.7 |

It will be appreciated by those skilled in the art that various omissions, ns and modifications may be made to the processes described above without departing e scope of the invention, and all such modifications and changes are intended to fall the scope of the invention, as defined by the appended claims.

What is claimed is:

1. A method for extending the lifetime of a photorefractive material or removing voids, cracks or other defects in a photorefractive material, comprising:
providing a photorefractive material, wherein the photorefractive material has an optical property that degrades when the photorefractive material is maintained at a temperature in the range of T₁ to T₂;
heating the photorefractive material to a temperature T₃ or higher for an annealing time that is effective to maintain or at least partially restore the optical property, wherein T₃ is greater than T₂; and
cooling the photorefractive material to a temperature in the range of T₁ to T₂.

2. The method of claim 1 in which T₁ is about 0° C. or below.

3. The method of claim 2 in which T₁ is about −50° C. or below.

4. The method of claim 3 in which the photorefractive material has a glass transition temperature that is about T₂ or less.

5. The method of claim 4 in which the glass transition temperature is in the range of about 150° C. to about 0° C.

6. The method of claim 5 in which the glass transition temperature is in the range of about 100° C. to about 0° C.

7. The method of claim 6 in which the glass transition temperature is in the range of about 50° C. to about 15° C.

8. The method of claim 1 in which T₂ is about 100° C. or greater.

9. The method of claim 1 in which at least a portion of the photorefractive material forms a second phase within the photorefractive material when the photorefractive material is maintained at a temperature in the range of T_{1 to T}₂.

10. The method of claim 9 in which the photorefractive material and the second phase combine to form a single phase during the heating of the photorefractive material to the temperature T₃ for the annealing time.

11. The method of claim 10 in which T₃ is more than about 1° C. above T₂.

12. The method of claim 10 in which T₃ is more than about 20° C. above T₂.

13. The method of claim 10 in which T₃ is in the range of about 100° C. to about 200° C.

14. The method of claim 10 in which T₃ is in the range of about 140° C. to about 160° C.

15. The method of claim 10 in which the annealing time is more than about 1 minute.

16. The method of claim 10 in which the annealing time is about 5 minutes or longer.

17. The method of claim 10 in which in which the cooling of the amorphous photorefractive material is conducted at a cooling rate that is effective to maintain the single phase.

18. The method of claim 17 in which the cooling rate is faster than about 5° C. per minute

19. The method of claim 17 in which the cooling rate is faster than about 50° C. per minute

20. The method of claim 17 in which the cooling rate is faster than about 100° C. per minute.

21. The method of claim 17 in which the heating of the photorefractive material to the temperature T₃ or higher is repeated.

22. A photorefractive article with an extended lifetime, comprising:
a photorefractive material, wherein the photorefractive material has an optical property that degrades when the photorefractive material is maintained at a temperature in the range of T₁ to T₂; and wherein the optical property of the photorefractive material is at least partially restored upon heating the photorefractive material to a temperature T₃ and cooling the photorefractive material to a temperature in the range of T_{1 to T}₂, wherein T₃ is greater than T₂;
a heat source operatively disposed to heat the photorefractive material; and
a substrate in contact with the photorefractive material.

23. The photorefractive article of claim 22 in which the photorefractive article is part of an optical device.

24. The photorefractive article of claim 23 in which the optical device is selected from the group consisting of phase conjugator, mirror, amplifier, spatial light modulator, optical processor, and holographic optical storage device.

25. The photorefractive article of claim 23 in which the photorefractive material comprises an amorphous photorefractive material.

26. The photorefractive article of claim 25 in which in which the amorphous photorefractive material is in the form of a film having a thickness in the range of about 1 micron to about 1 millimeter.

27. The photorefractive article of claim 22 in which the substrate has a shear modulus greater than about 10⁷ Pa

28. The photorefractive article of claim 22 in which the substrate has an optical density of about 0.2 or less

29. The photorefractive article of claim 22 in which the substrate has an optical density of about 0.05 or less

30. The photorefractive article of claim 22 in which the substrate comprises a material selected from the group consisting of soda lime glass, silica glass, borosilicate glass, gallium nitride, gallium arsenide, sapphire, quartz glass, polyethylene terephthalate, and polycarbonate.

31. The photorefractive article of claim 30 in which the substrate is soda lime glass

32. The photorefractive article of claim 22 further comprising at least one substantially transparent electrode.

33. The photorefractive article of claim 32 in which the transparent electrode is a film comprising a material selected from the group consisting of conducting metal oxide, conducting polymer, and metal.

34. The photorefractive article of claim 33 in which the transparent electrode is a film comprising a material selected from the group consisting of indiumtinoxide, tin oxide, zinc oxide, polythiophene, polyphenylenevinylene, gold, aluminum, and polyaniline.

35. The photorefractive article of claim 32 in which the transparent electrode is a film comprising indiumtinoxide.

36. The photorefractive article of claim 35 in which the photorefractive article is part of an optical device.

37. The photorefractive article of claim 36 in which the optical device is selected from the group consisting of phase conjugator, mirror, amplifier, spatial light modulator, optical processor, and holographic optical storage device.

38. The photorefractive article of claim 36 in which the heat source is at least partially embedded in the photorefractive material.

39. The photorefractive article of claim 36 in which the heat source comprises a bar heater.

40. The photorefractive article of claim 36 in which the heat source comprises an infrared laser.

41. The photorefractive article of claim 40 in which the infrared laser is selected from the group consisting of diode laser, fiber laser and gas laser.

42. The photorefractive article of claim 40 further comprising a lens operatively disposed to focus the infrared laser on the photorefractive article.
